(19) United States
(12) Patent Application Publication
(10) Pub. No.: US 2016/0303501 A1
(43) Pub. Date: Oct. 20, 2016

(54) END CAP AND AIR FILTER INCORPORATING SAME

(71) Applicant: John Paul Musone, York, PA (US)

(72) Inventor: John Paul Musone, York, PA (US)

(73) Assignee: CLARK FILTER, INC., Lancaster, PA (US)

(21) Appl. No.: 14/688,541

(22) Filed: Apr. 16, 2015

(51) Int. Cl. B01D 46/52; B01D 46/00

(52) U.S. Cl. CPC B01D 46/521; B01D 46/0001; B01D 46/0002

(57) ABSTRACT

An end cap and filter element incorporating the same is provided. In one embodiment, the filter element includes a top end cap and a bottom end cap. The top end cap having a ring-shaped well that is defined along its bottom side and a rectangular flange projecting upward along its top side. The top end cap further comprising a rectangular gasket disposed proximate to the rectangular flange of the top end cap and contained within the rectangular flange of the top end cap. The bottom end cap is a closed end cap and is spaced below the top end cap. The filter element further comprises a ring of filter media. The filter media is bonded with the ring shaped well of the top end cap and the closed bottom end cap.

### FIELD OF THE INVENTION

This invention generally relates to an end cap having a gasket and a filter element incorporating the same.

### BACKGROUND OF THE INVENTION

As known in the art, and exemplified in U.S. Pat. No. 5,547,480, U.S. Pat. No. 5,167, 683, and U.S. Pat. No. 5,120,337 the disclosures of which are incorporated by reference herein in their entireties, filter elements or filter cartridges (collectively referred to as “filter elements”) are used to remove particulates from a fluid, such as, for example, air. Filter elements come in a variety of different shapes, sizes, and configurations depending on their particular application and use.

In some circumstances, the filter arrangements include an end cap having a rectangular flange and a gasket to seal the filter arrangement against a surface as exemplified in U.S. Pat. No. 4,746,339, U.S. Pat. No. 5,013,333, U.S. Pat. No. 5,820,646, U.S. Pat. No. 5,961,696, U.S. Pat. No. 6,245,130, and U.S. Pat. No. 8,673,037, which are hereby incorporated by reference in their entireties. The present invention provides improvements for filter elements, in particular to the end cap thereof. These and other improvements to filter elements, as well as additional inventive features, will be apparent from the description of the invention provided herein.

### BRIEF SUMMARY OF THE INVENTION

In one aspect, the invention provides a filter element comprising a rectangular top end cap that has a ring-shaped well that is defined along the bottom side. In addition, the top end cap can have a rectangular flange projecting upward along the top side of the top end cap. The filter can have a closed bottom end cap that is spaced below the top end cap. The filter can have a ring of filter media that is bound by adhesive to the ring-shaped well of the top end cap as well as to the closed bottom end cap. In addition, the filter element can have a rectangular gasket that is disposed proximate to the rectangular flange and is contained within the rectangular flange.

In yet another aspect, the top end cap can be a stamp formed sheet metal that has a thickness between 0.5 mm and 1.5 mm. In another aspect, the top end cap can be a unitary single piece structure.

In another aspect, the ring-shaped well can have a depth between 1.5 mm and 27.5 mm and a width between 45 mm and 65 mm. In still another aspect, the rectangular flange can have a height between 8 mm and 18 mm and a width between 0.5 mm and 1.5 mm. In yet another aspect, the rectangular gasket can have a width between 12 mm and 24 mm and a height between 15 mm and 35 mm.

In another aspect, the ring-shaped well can have a base surface that is defined by an innermost wall and an outermost wall. In yet another aspect, the innermost wall can act to define an aperture in the rectangular top end cap where feed fluid can flow in a linear direction along a first axis into a dirty air plenum of the filter element. In another aspect, the diameter of the aperture can be between 180 mm and 360 mm. In another aspect, the bottom end cap can have a second ring-shaped well defined along a top side of the bottom end cap. In another aspect, the top end cap can be stamp formed sheet metal that has a thickness between 0.5 mm and 1.5 mm.

In yet another aspect, the invention provides a filter element comprising a rectangular top end cap that has a ring-shaped well that is defined along the bottom side. In addition, the top end cap can have a rectangular flange projecting upward along the top side of the top end cap. The filer can comprise a closed bottom end cap that is spaced below the top end cap. The filter may have a ring of filter media that is bound by adhesive to the ring-shaped well of the top end cap as well as to the closed bottom end cap. In addition, the filter element can include a rectangular gasket that is disposed proximate to the rectangular flange and is contained within the rectangular flange. Furthermore, the top end cap may be a unitary single piece structure that has at least one strengthening structure formed into the top end cap to prevent the bending of the top end cap.

In another aspect of the invention, the gasket may be composed of rubber, silicone, metal, cork, felt, neoprene, nitrile rubber, fiberglass, polytetrafluoroethylene, polyurethane or a plastic polymer. In yet another aspect of the invention, the adhesive may be an epoxy, PVC resin, polyurethane, cyanoacrylate or acrylic polymer.

In yet another aspect of the invention, the rectangular end cap can have a first and a second long edge, and a first and a second short edge. Where the first and second long edge have a length between 34 cm and 70 cm and the first and the second short edge have a length between 27 cm and 55 cm.

In yet another aspect of the invention, the ring of filter media may be composed of a pleated filter media. In yet still another aspect of the invention, the ring of filter media can remove 99.97% of airborne particles 0.3 μm in diameter.

In yet still another aspect of the invention, a method of making a filter element comprising stamping a piece of sheet metal to form a rectangular top end cap and having a rectangular flange along the top surface of the top end cap and a ring-shaped well along a bottom surface of the top end cap. The ring-shaped well may have an innermost wall and an outermost wall that define the base surface of the ring-shaped well. The method then comprises bonding a rectangular gasket proximate to the rectangular flange so that it is contained within the rectangular flange on the top side of the top end cap. The method further comprising obtaining an annulus of filter media that has an inner radius equal to the innermost wall of the well of the top end cap and an outer radius equal to the outermost wall of the well of the top end cap. Then aligning the annulus of filter media with the ring-shaped well of the top end cap and then bonding the annulus of filter media to the ring-shaped well of the top end cap. The method further comprising obtaining a closed end cap and bonding the closed end cap to the annulus of filter media between the first radius of the annulus of filter media and the second radius of the annulus of filter media.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective view of one embodiment of a filter element;

FIG. 2 is a top perspective view of one embodiment of the top end cap;

FIG. 3 is a top perspective view of the opposite side of the top end cap of FIG. 2;

FIG. 4 is a bottom perspective view of one embodiment of the top end cap;

FIG. 5 is a bottom perspective view of the opposite side of the top end cap of FIG. 4;

FIG. 6 is a top view of one embodiment of the top end cap;

FIG. 7 is a bottom view of one embodiment of the top end cap;

FIG. 8 is a side view of the top end cap illustrating the long edge of the top end cap;

FIG. 9 is a side view of the opposing side of the top end cap illustrated in FIG. 8;

FIG. 10 is a side view of the top end cap illustrating the short edge of the top end cap;

FIG. 11 is a side view of the opposing side of the top end cap illustrated in FIG. 10

FIG. 12 is a partial cross-sectional view of the top end cap;

FIG. 13 is a partial cross-sectional view of one embodiment of the filter element;

FIG. 14 is a partial cross section view of a second embodiment of the filter element.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

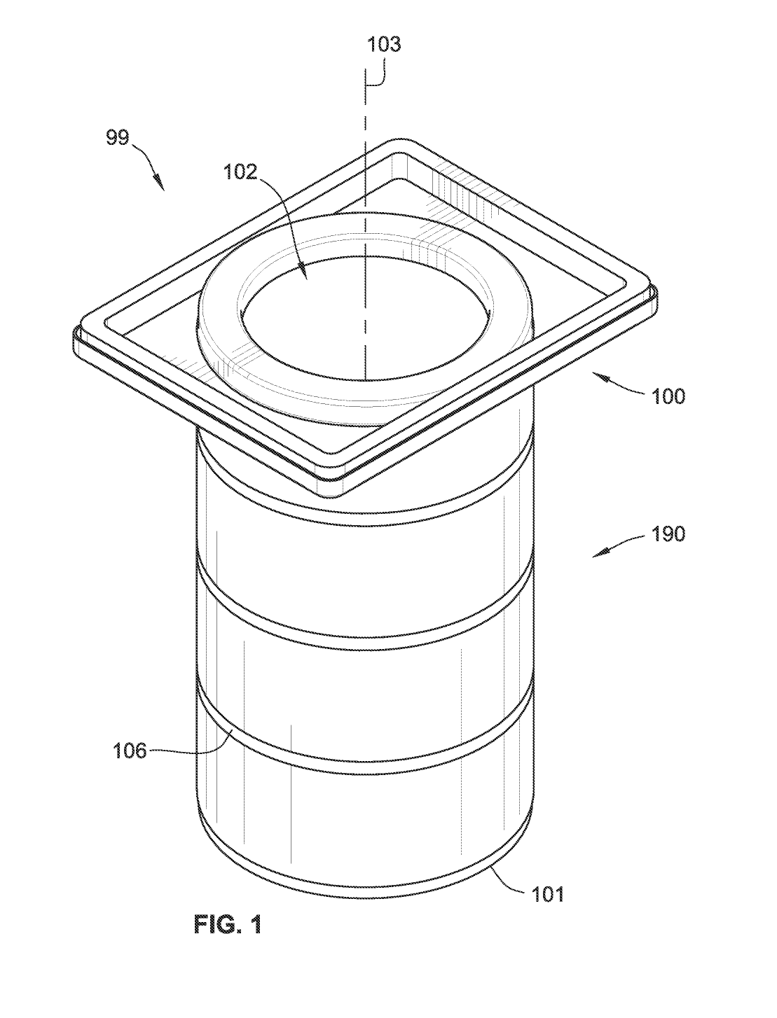

FIG. 1 illustrates a top perspective view of one embodiment of a filter arrangement 99 governed by the principles of this application. The filter arrangement 99 includes a ring filter media 190 that can have support straps 106 that can be, but are not limited to nylon straps. As will be appreciated by one of ordinary skill in the art the support straps 106 can be bound to the ring of filter media 190 using an adhesive to provide structural support to the ring of filter media 190.

Furthermore, FIG. 1 illustrates the ring of filter media 190 coupled to a rectangular top end cap 100 at a first end and a bottom end cap 101 at a second end. The rectangular top end cap 100 includes an aperture 104 (see FIG. 7) that allows feed liquid to enter the dirty plenum 102 along a first axis 103 of the filter element 99. The bottom end cap 101 is a closed end cap. In use, the bottom end cap 101 acts to block the linear flow of feed liquid and forces the feed liquid to flow radially through the ring of filter media 190.

The rectangular top end cap 100 can be made of aluminum stamp formed sheet metal having a thickness between 0.65 mm and 1.35 mm. However, as will be appreciated by one of skill in the art, the rectangular end cap 100 can be composed of any suitable material generally known in the art including, but not limited to, copper, brass, steel, or titanium. Likewise, as will be appreciated by those of skill in the art, the thickness of the rectangular end cap 100 can be any suitable thickness generally known in the art. Additionally, those of skill in the art will appreciate that the thickness of the rectangular top end cap 100 can vary depending on the operating environment in which the rectangular end cap is expected to be deployed. For example, such factors include, but are not limited to, the composition material of the rectangular end cap 100, the pressure of the system using the rectangular end cap 100, and the ambient temperature of the environment the rectangular end cap 100 is employed.

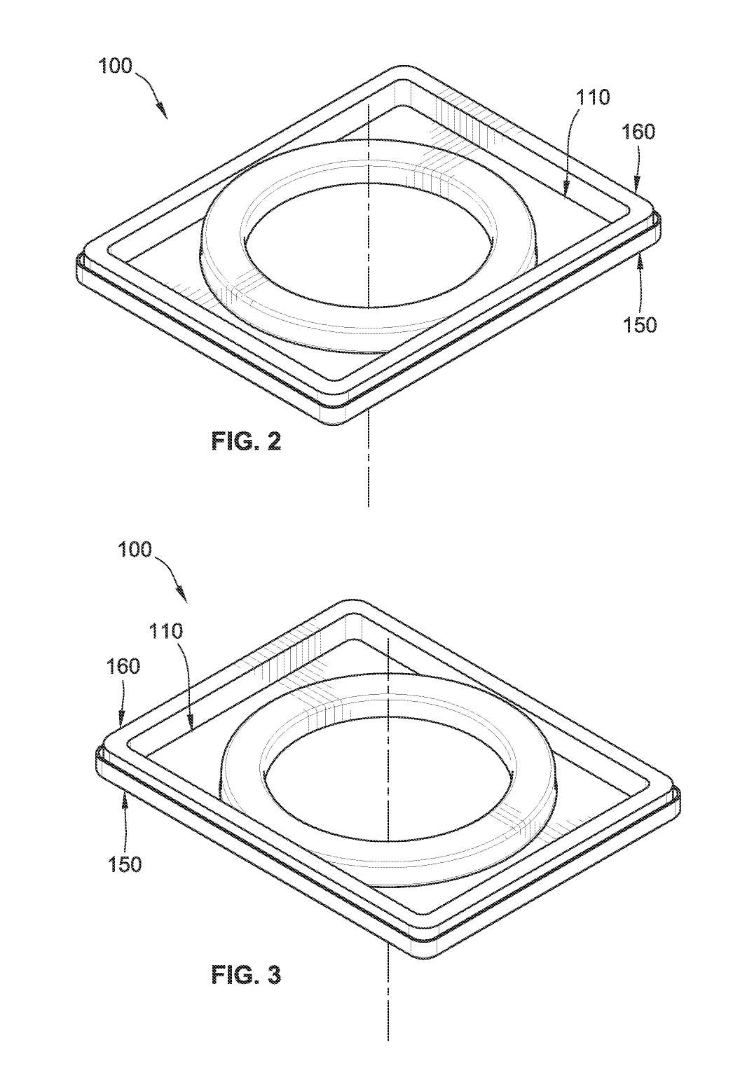

FIGS. 2 and 3 show a first and second top perspective view of the rectangular top end cap 100. The top surface 110 defines the top-most surface of the rectangular top end cap 100. The top surface 110 has an upwardly projecting rectangular flange 150 and a gasket 160 is disposed proximate and contained within the rectangular flange 150. As will be appreciated by one of skill in the art, the gasket can be made from any suitable material for forming a seal as generally known in the art, including, but not limited to, rubber, silicone, metal, cork, felt, neoprene, nitrile rubber, fiberglass, polytetrafluoroethylene, polyurethane or a plastic polymer.

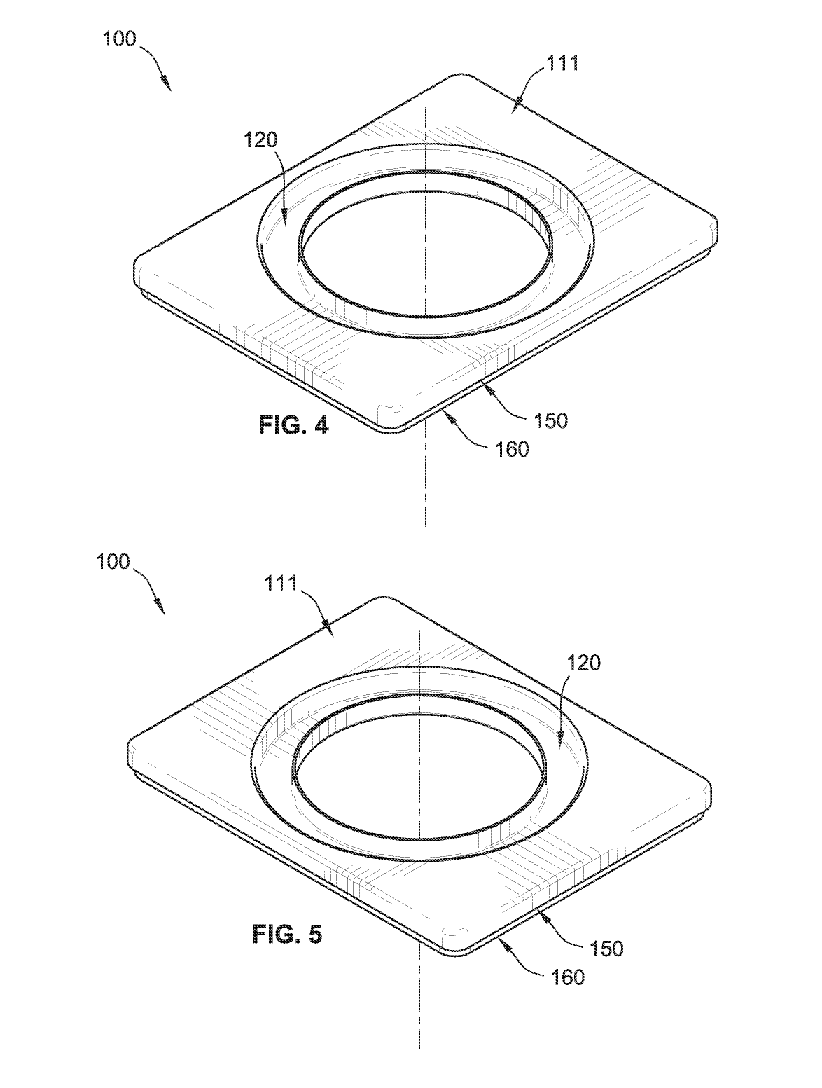

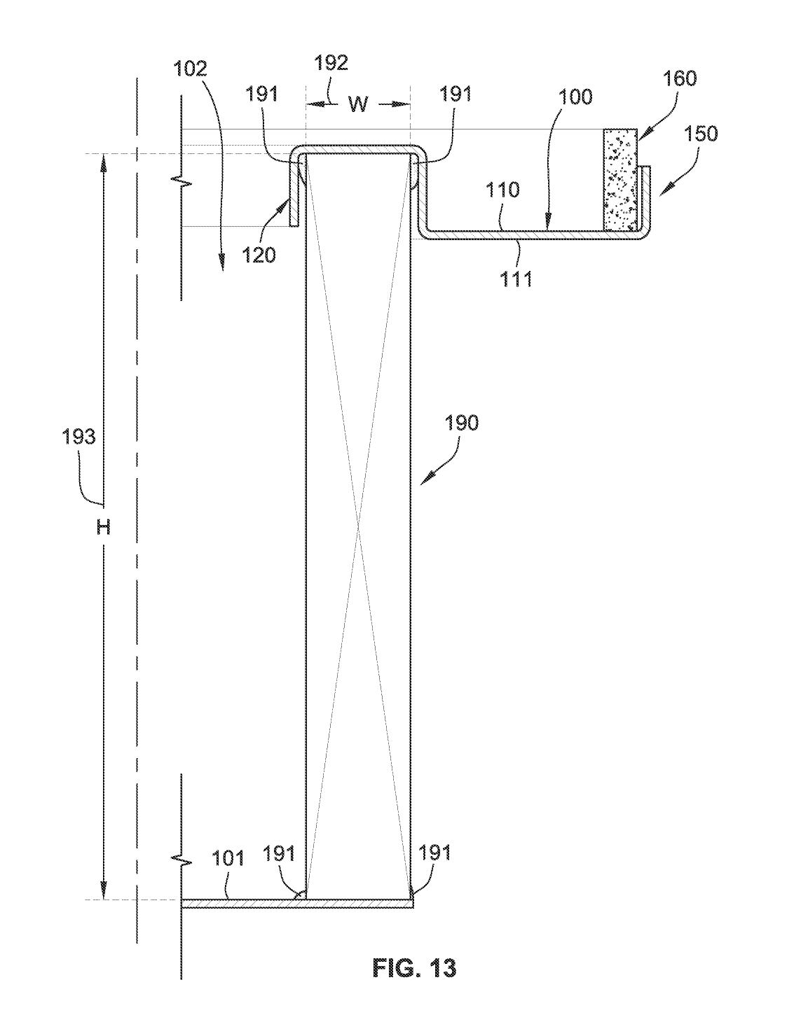

FIGS. 4 and 5 show a bottom perspective view of the rectangular top end cap 100. The top end cap 100 has a bottom surface 111 that has a ring-shaped well 120. As will be discussed in detail later in the specification, the well 120 of the bottom surface 111 acts as a bracket to receive the tubular ring of filter media 190, as best illustrated in FIG. 13.

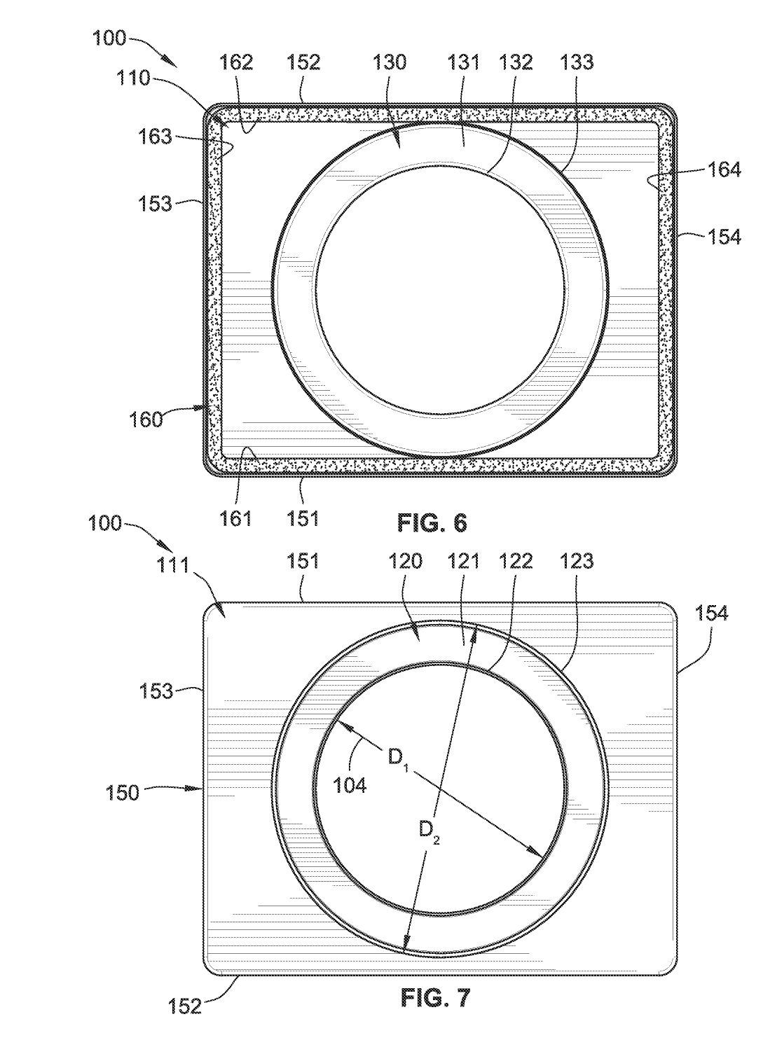

FIG. 6 is a top view of the rectangular filter end cap 100 showing further detail of the top surface 110. The rectangular top end cap 100 has a first long edge 151 and a second long edge 152 as well as a first short edge 153 and a second short edge 154. In addition, the rectangular top end cap 100 further comprises at least one gasket 160 disposed proximate to and contained within the rectangular flange 150. The gasket 160 has a first long seal portion 161 and a second long seal portion 162 as well as a first short seal portion 163 and a second short seal portion 164. In addition, the top surface 110 includes a ring-shaped protuberance 130 created by the ring-shape well 120 formed into the bottom surface 111 of the top end cap 100, as illustrated in FIGS. 4 and 5. The ring-shaped protuberance 130 has a base surface 131, an innermost sidewall 132, and an outermost sidewall 133. The innermost sidewall 132 acts to define the aperture 104 of the top end cap 100, as best illustrated in FIG. 1.

FIG. 7 illustrates a bottom view of the rectangular top end cap 100 showing the bottom surface 111 of the top end cap 100. As illustrated, the top end cap 100 has an aperture 104 defined by the inner diameter D1 of the well 120. Likewise, as seen in FIG. 7 the well 120 has an outer diameter indicated by D2. In one embodiment, the well 120 can have an inner diameter D1 between 70 and 140 mm and an outer diameter D2 between 100 and 200 mm. As will be recognized by those of ordinary skill in the art other embodiments of filter element 99 can have a well 120 with an inner diameter D1 less than 70 mm or an inner diameter greater than 140 mm. Likewise, as will be recognized by one of ordinary skill in the art, other embodiments can incorporate a well 120 with an outer diameter D2 less than 100 mm or greater than 200 mm.

Further illustrated in FIG. 7, is a well 120 located on the bottom surface 111 of the top end cap 100. The well 120 has a base 121 disposed between an inner wall 122 and an outer wall 123. The innermost wall 122 and outermost wall 123 are in an opposing spaced relationship with the distance between the innermost wall 122 and the outermost wall 123 defining the base surface 121 of the well 120.

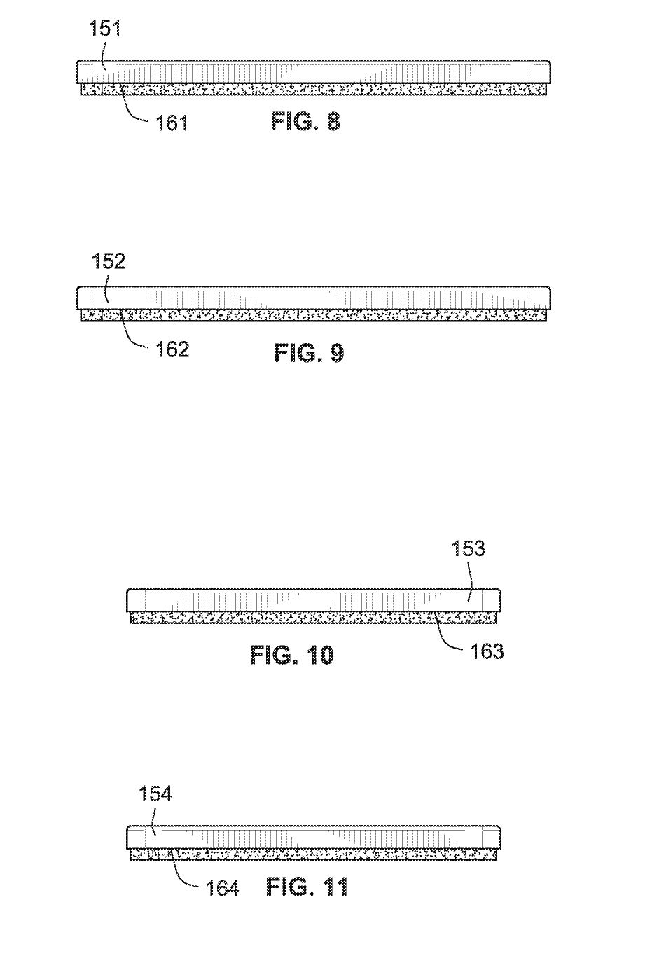

FIGS. 8-11 illustrate the individual edges 151, 152, 153, and 154 in detail. The first long edge 151, the second long edge 152, and the first short edge 153, and the second long edge 154 each have an upwardly projecting flange that in total form the rectangular flange 150 that encloses the perimeter of the top surface 110 of the rectangular top end cap 100. Likewise, FIGS. 8-11 illustrate gasket seals 161, 162, 163, and 164. The first long seal 161, the second long seal 162, and the first short seal 163 and the second short seal 164 form gasket 160 that is located proximate to the rectangular flange 150 and enclose a second perimeter located inside the perimeter formed by the rectangular flange 150, as best illustrated in FIG. 6.

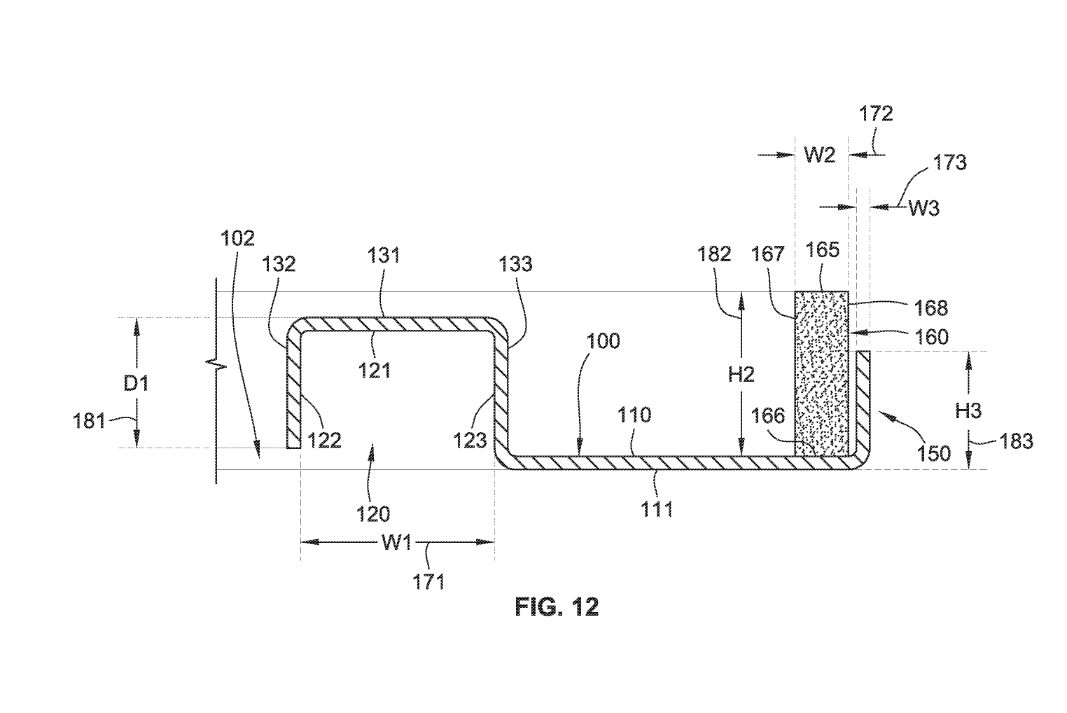

FIG. 12 illustrates a cross-sectional view of the rectangular top end cap 100. As illustrated, the base 121 of the well 120 has a width 171 defined by the inner wall 122 and outer wall 123. In the illustrated embodiment, the width 171 is in the range of 4.5 cm and 6.5 cm. Furthermore, the well 120 has a depth 181 defined by the height of inner wall 122 and outer wall 123. In the illustrated embodiment, the depth 181 of the well 120 is in the range of 1.25 cm and 2.75 cm. FIG. 12 further illustrates, the gasket 160 having a width 172 defined by a first and second short gasket wall 165 and 166. In the illustrated embodiment, the width 172 of the gasket 160 is in the range of 1.2 and 2.4 cm. Likewise, the gasket 160 has a height 182 defined by the height of the first long gasket wall 167 and the second long gasket wall 168. In the illustrated embodiment, the height 182 of the gasket 160 is in the range of 1.5 cm and 3.5 cm. FIG. 12 further illustrates the width 173 of the flange 150. In the illustrated embodiment, the width 173 of the flange is in the range between 0.65 mm and 1.35 mm. Likewise, FIG. 12 illustrates the height 183 of the flange 150. In the illustrated embodiment, the height 183 of the flange 150 is in the range of 0.8 cm and 1.8 cm. The depth 181, height 182, height 183, width 171, width 172, and width 173 are ranges for only a single embodiment of the present invention. Those of ordinary skill in the art will appreciate that other embodiments governed by this application can have any number of measurements that are greater than or less than the measurements provided in the ranges above.

FIG. 13 shows a cross-section of filter element 99 illustrating the seal formed between the ring of filter media 190 and the top end cap 100 and the bottom end cap 101. In one embodiment, the ring of filter media 190 can have a height 193 between 26 and 53 cm. As will be recognized by those of ordinary skill in the art other embodiments governed by this application may incorporate a ring of filter media 99 with a height 193 less than 26 cm or greater than 52 cm. In addition, the ring of filter media 190 has a width 192 that can be of any size that allows the ring of filter media 190 to fit within the well 120. Furthermore, the ring of filter media 190 can be composed of any suitable material known by those of skill in the art including, but not limited to, polyester blend, polyester blend-FR, polyester blend with carbon, polyglass blend, nanofiber-FR, or nanofiber.

As further illustrated in FIG. 13, the ring of filter media 190 aligns in such a manner that the upper portion of the ring of filter media 190 is positioned within the well 120 of the top end cap 100. As illustrated, adhesive 191 is used to form a seal between the ring of filter media 190 and the open top end cap 100 that prevents the leaking of feed liquid between the ring of filter media 190 and the top end cap 100. Likewise, adhesive 191 forms a seal between the ring of filter media 190 and the bottom end cap 101 that prevent the leaking of feed liquid between the ring of filter media 190 and the bottom end cap 101. The well 120 of the top end cap 100 provides a greater contact area between the top end cap 100 and the ring of filter media 190. One of ordinary skill in the art will understand that the well 120 increases the shared contact area between the top end cap 100 and the ring of filter media 190. The shared contact area acts to strengthen the seal between the top end cap 100 and the ring of filter media 190 by creating a larger shared surface in which adhesive 191 can be applied, which in turn strengthens the seal between the top end cap 100 and the ring of filter media 190.

In use, feed liquid under pressure will linearly flow through aperture 104 into the dirty plenum 102 of the filter element 99. As the feed liquid enters the dirty plenum 102, the closed second end cap 101 blocks the linear flow of the feed liquid. As discussed above, the feed liquid is prevented from passing between the first end cap 100 and the ring of filter media 190 and the second end cap 101 and the ring of filter media 190 by the seals created by adhesive 191. As one of ordinary skill in the art will readily recognize the feed fluid will flow from the high-pressure environment of the dirty air plenum 102 to the low-pressure environment at the exterior of the ring of filter media 190. As the feed liquid flows through the ring of filter media 190 the filter media traps oversized particles that cannot pass through the filter media while the remaining feed liquid passes through the ring of filter media 190 and exits as filtrate.

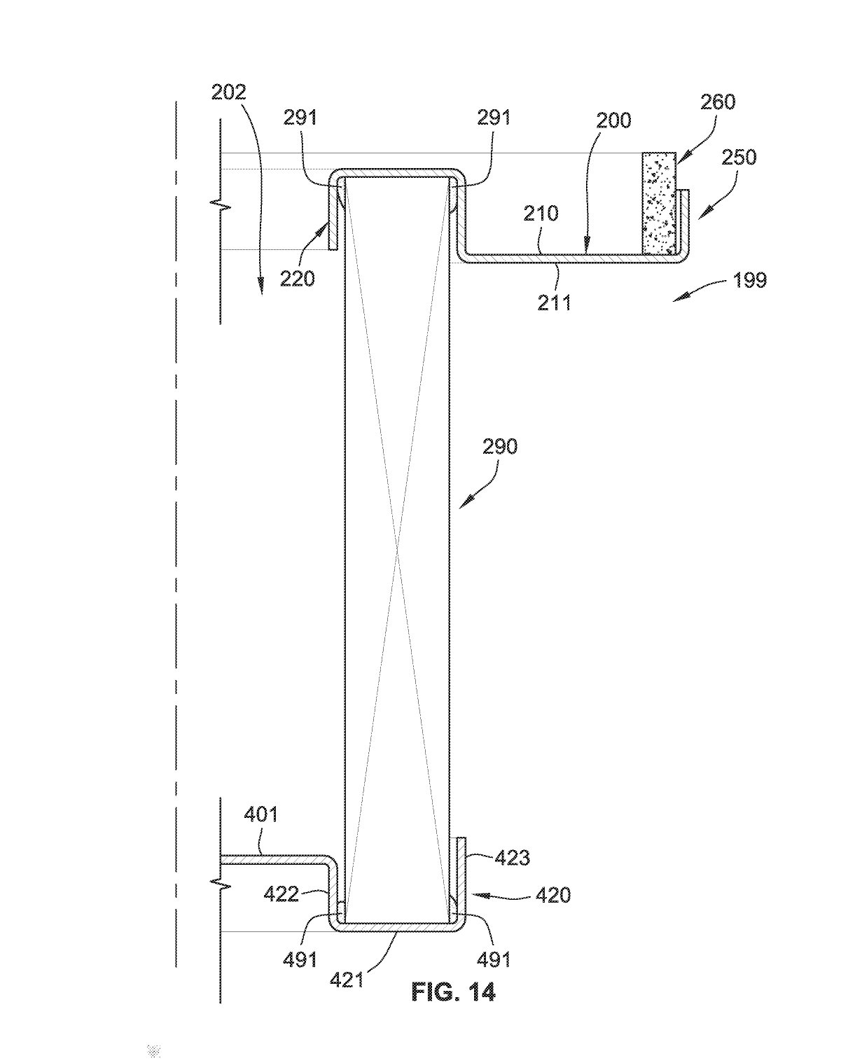

FIG. 14 illustrates a cross-section of a second embodiment of a filter element 199 governed by this application. This embodiment is similar to the embodiment described above with the exception that the filter element 199 is illustrated as incorporating a bottom end cap 420 with having a well 420 to accept the lowermost portion of the ring of filter media 290.

Turning back to FIG. 14, this embodiment has a top end cap 200 having a top side 210 and a bottom side 211. The top end cap 200 includes a well 220, a gasket 260, a rectangular flange 250, and a ring of filter media 290. Filter element 199 includes a bottom end cap 401 that has a well 420. The well 420 has a base 421 and an inner wall 422 and an outer wall 423. As illustrated, the inner wall 422 and the outer wall 423 act as a bracket for the lower portion of the ring of filter media 290 in a similar manner to well 220 of the top end cap 200. In a similar fashion to filter element 99 described above, adhesive 291 forms a seal between the top end cap 200 and the ring of filter media 290 that prevents the leaking of feed liquid. Likewise, adhesive 291 forms a similar seal between the bottom end cap 401 and the ring of filter media 290 that prevents the leaking of feed liquid. For brevities sake, the manner of operation of filter element 199 is identical to the manner of operation of the filter element 99 described above in detail.

Although not illustrated, all of the embodiments described herein can use any type of closed second end cap 101 and 201 and still achieve the various advantages described herein. Further, the embodiments illustrated in FIG. 14 incorporate all of the features of the embodiment described in FIGS. 1-13, with the exception of the differences identified in the preceding.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1.-20. (canceled)

21. A filter comprising:
a rectangular top end cap having a ring-shaped well that is defined along a bottom side and a rectangular flange projecting vertically upward along a top side, the top side including an uppermost surface over the ring shaped well and a dipped region below the uppermost surface radially outboard of the ring-shaped well, the rectangular top end cap being a 1-piece unitary single piece structure and a stamped metal member comprising a thickness between 0.65 mm and 1.35 mm, wherein the ring-shaped well has a depth between 12.5 mm and 27.5 mm and a width between 45 mm and 65 mm, wherein the rectangular flange has a height between 8 mm and 18 mm and a width between 0.5 mm and 1.5 mm; wherein the ring-shaped well has a base surface defined by an innermost wall and an outermost wall, wherein the innermost wall defines an aperture in the rectangular top end cap, wherein feed fluid can flow in a linear direction along a first axis into a dirty air plenum of the filter element, wherein the diameter of the aperture is between 180 mm and 360 mm;
a closed bottom end cap spaced below the top end cap;
a cylindrical ring of pleated filter media bonded to the ring-shaped well and the closed bottom end cap; and
consisting of a single gasket attached to the top end cap at a location in the dipped region below the uppermost surface proximate and contained within the rectangular flange with the rectangular gasket projecting above the flange and above the uppermost surface of the annular well, wherein the rectangular gasket has a width between 12 mm and 24 mm and a height between 15 mm and 35 mm, the gasket having a flat top surface.
